(19) United States
(12) Patent Application Publication
(10) Pub. No.: US 2003/0234552 A1
(43) Pub. Date: Dec. 25, 2003

(54) Adjustable striker wheel

(76) Inventor: Dmitriy Zelmanov, Southfield, MI (US)

Correspondence Address: HARNESS, DICKEY & PIERCE, P.L.C., P.O. BOX 828, BLOOMFIELD HILLS, MI, 48303, US

(21) Appl. No.: 10/174,741

(22) Filed: Jun. 19, 2002

(51) Int. Cl. B60N 2/02

(52) U.S. Cl. 296/65.01

(57) ABSTRACT

An adjustment mechanism is provided and includes a main pivot adapted for attachment to a vehicle body, a body rotatably supported by the main pivot, a locking assembly operably supported by the body, and a cam plate rotatably supported by the main pivot. The cam plate is in operable communication with the locking assembly to selectively actuate the locking assembly between a locked and an unlocked position. The locking assembly is in operable communication with the body such that when the locking assembly is in the unlocked position, the body is allowed to be rotatably positioned in one of a plurality of positions.

### FIELD OF THE INVENTION

The present invention relates to adjustable striker mechanisms and more particularly to an improved adjustable striker mechanism for seat assemblies.

### BACKGROUND OF THE INVENTION

In automotive applications, it is increasingly desirable that a vehicle be capable of accommodating varying requirements, such as cargo carrying and the like. It is further desirable that a vehicle be capable of accommodating varying requirements with respect to occupant comfort. To that end, reconfiguration of the vehicle seating system plays a significant role. Generally speaking, articulation of a seatback enables a vehicle interior to be configurable for accommodating cargo-carrying needs and to provide occupant comfort. Latching mechanisms are often used to selectively anchor a seatback to a stationary striker assembly, thereby securing the seat back to a vehicle structure. In such a system, a conventional latching mechanism cooperates with a stationary striker to provide the seat back with one of either a latched position or an unlatched position. In the latched position the seat back is secured to the vehicle structure in a fixed relationship. In the unlatched position the seat back is free to be dumped forward or folded flat. Current striker assemblies suffer from the disadvantage that they only allow for the seat back to be latched in a single position, thereby hampering occupant comfort.

In addition to limiting occupant comfort, stationary striker assemblies also limit the flexibility of a cargo area of a vehicle located behind a vehicle seat. Current seating systems accommodate large cargo by folding the seat back in a substantially fold flat position such that the seat back is generally parallel to the seat bottom. In other current systems, the seat back is again folded flat, and together with the seat bottom, the seat back is articulated or dumped forward, thereby increasing the cargo area of the vehicle. Current systems, while adequately providing for increased cargo areas in a vehicle, do not provide for occupant use of a seat when increased cargo capacity is required.

Therefore a striker assembly that provides for angular adjustment of a seat back in a plurality of positions relative to the seat bottom and securely latches a seat to a vehicle structure when in a latched position is desirable in the industry. Furthermore, providing increased cargo-carrying capability in the cargo area of a vehicle while still maintaining use of the vehicle seat is also desirable.

### SUMMARY OF THE INVENTION

Accordingly, the present invention provides an adjustment mechanism, comprising a main pivot adapted for attachment to a vehicle body, a body rotatably supported by the main pivot, a locking assembly operably supported by the body, a cam plate rotatably supported by the main pivot and in operable communication with the locking assembly to selectively lock the body in a plurality of positions relative to the main pivot.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an adjustment mechanism in accordance with the principles of the present invention;

FIG. 2a is an exploded view of the adjustment mechanism of FIG. 1;

FIG. 2b is a more detailed exploded view of certain components of FIG. 2a;

FIG. 3 is a perspective view of the adjustment mechanism with part of a body removed to show the internal components of the adjustment mechanism in the locked position;

FIG. 4 is a perspective view of the adjustment mechanism with part of a body removed to show the internal components of the adjustment mechanism in the locked position;

FIG. 5 is a side view of the adjustment mechanism with part of a body removed to show the adjustment mechanism in a first locked position;

FIG. 6 is a side view of the adjustment mechanism with part of a body removed to show the adjustment mechanism in an unlocked position;

FIG. 7 is a side view of the adjustment mechanism with part of a body removed to show the adjustment mechanism in a second locked position;

FIG. 8 is a side view of the adjustment mechanism in a seat assembly;

FIG. 9 is a side view of the adjustment mechanism in a first locked position and a seat assembly in a first position;

FIG. 10 is a side view of the adjustment mechanism in a second locked position and a seat assembly in a second position; and

FIG. 11 is a side view of the adjustment mechanism in a third locked position and a seat assembly in a third position.

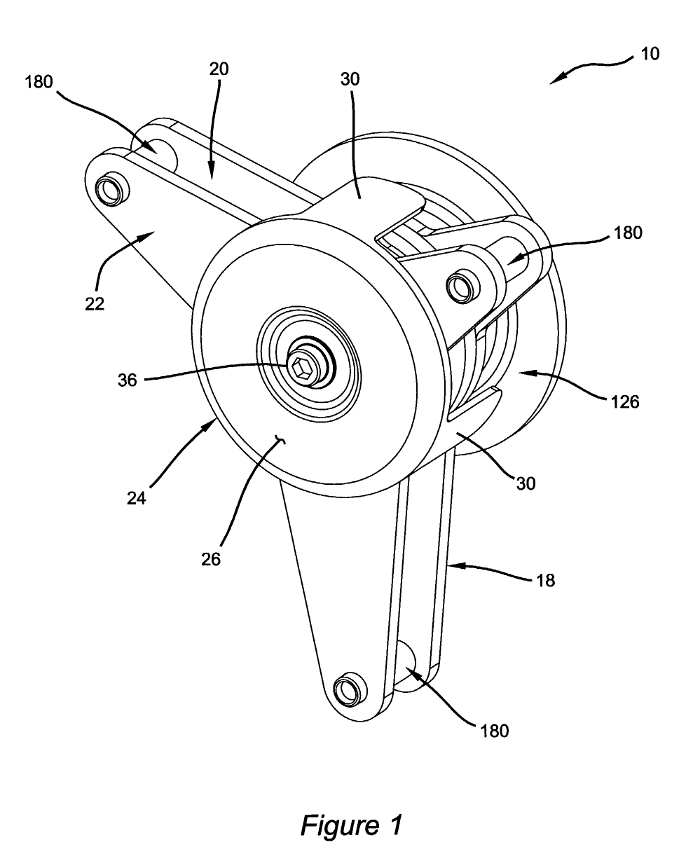

### DETAILED DESCRIPTION OF THE PREFERRED EMBODIMENTS

The following description of the preferred embodiment is merely exemplary in nature and is in no way intended to limit the invention, its application, or uses.

With reference to the drawings, an adjustment mechanism 10 is provided and includes a cam plate 12, a locking assembly 14, a main pivot 16 and a body 18. The locking assembly 14 and cam plate 12 are in operable communication with one another and are supported by the body 18 and the main pivot 16. The body 18 includes first and second striker plates 20,22 between which the various components are disposed.

An actuation member 24 is provided to selectively actuate the cam plate 12, in turn selectively actuating the locking assembly 14. The actuation member 24 includes first and second faces 26,28 and a plurality of engagement arms 30. The first face 26 includes centrally disposed axial recess 32 having an attachment aperture 34 formed therethrough for receiving a cover bolt 36. The second face 28 includes an inner extrusion 38 having a reaction face. In the preferred embodiment, the actuation member 24 includes three engagement arms 30 extending therefrom, each having an engagement face along its length for interaction with the body 18 as will be discussed further below.

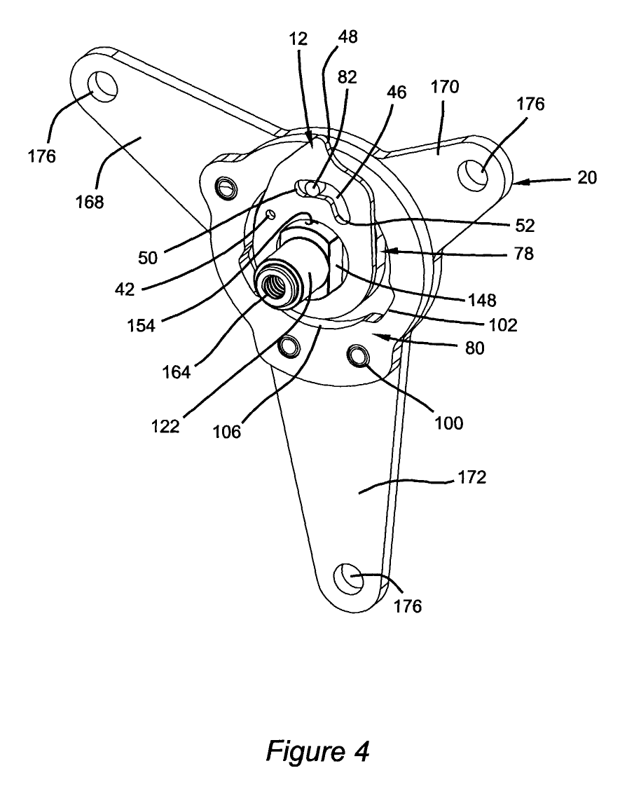

The cam plate 12 is in operable communication with the actuation member 24 and the locking assembly 14 and includes an attachment aperture 40, a spring aperture 42 for attachment of a cam return spring 44, a cam slot 46, and an engagement face 48 disposed generally opposite the attachment aperture 40. As best shown in FIG. 4, the cam slot 46 is a generally L-shaped slot and includes a first and second end 50,52, each having a reaction face. The attachment aperture 40 is received by the main pivot 16 for rotational attachment thereto.

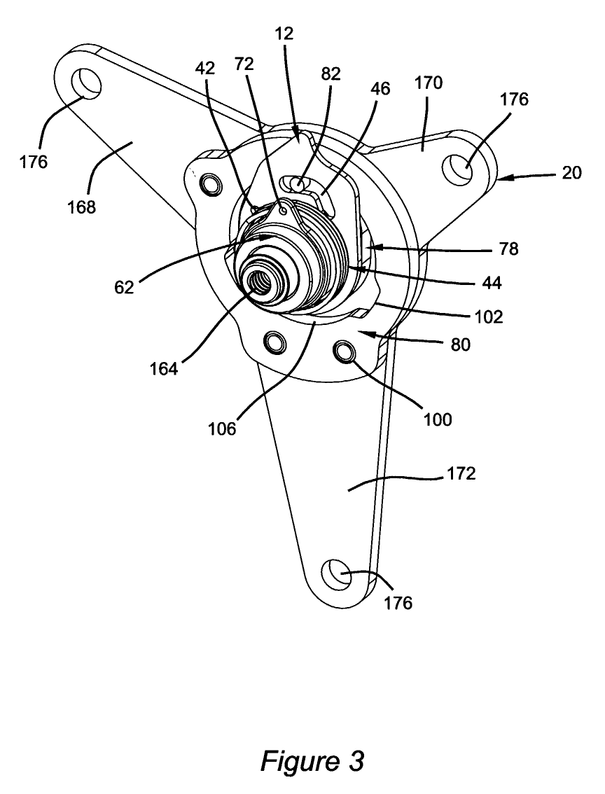

The cam return spring 44 biases the cam plate 12 into positioning the locking assembly 14 in a locked position as described in more detail below. The cam return spring 44 includes a first and second end 54,56 having attachment posts 58,60 integrally formed thereon. As best shown in FIG. 3, the first end 54 includes the first attachment post 58 for attachment to the spring aperture 42 of the cam plate 12 while the second end 56 includes the second attachment post 60 for attachment to a spring anchor 62.

The spring anchor 62 is a substantially cylindrical member having coaxial first and second cylindrical sections 64,66 while the second cylindrical section 66 matingly receives the main pivot 16, the first cylindrical section 64 has a constant cross-section along its length and receives a first bushing 68 for interaction with the second striker plate 22. The second cylindrical section 66 includes an axial flange 70 and integral feet 74,76. The axial flange 70 has a spring aperture 72 formed therethrough for receiving the second post 60 of the cam return spring 44. The integral feet 74,76 extending laterally from the cylindrical section 66 for interaction with the main pivot 16.

The locking assembly 14 is in operable communication with the cam plate 12 and the body 18 and generally includes a slider plate 78 and a sector plate 80. The slider plate 78 includes a slider post 82, a locking flange 84, and an attachment aperture 86 formed therethrough. The attachment aperture 86 is received by the main pivot 16 for slidable attachment thereto and includes first and second reaction surfaces 88,90 and first and second engagement faces 91,92. The slider post 82 is a substantially cylindrical member disposed generally perpendicular to the longitudinal plane of slider plate 78, includes a bearing surface 93, and is integrally formed on the slider plate 78. While the present invention discloses a slider post 82 integrally formed on the slider plate 78, it should be noted that a slider post 82 and slider plate 78 as separate members fixedly assembled by suitable means should be considered within the scope of the invention. The locking flange 84 is disposed adjacent the base of the slider post 82 and includes an engagement face 94.

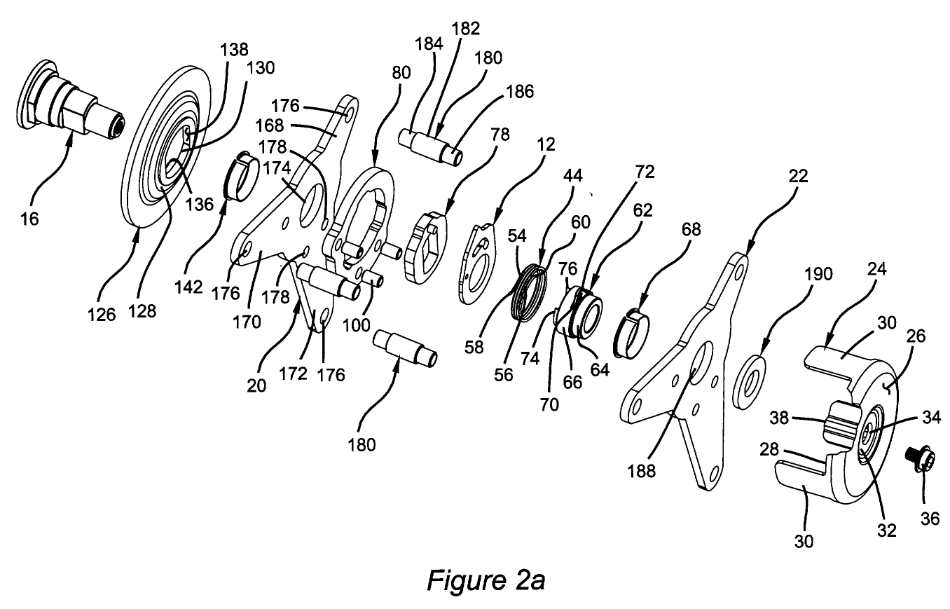

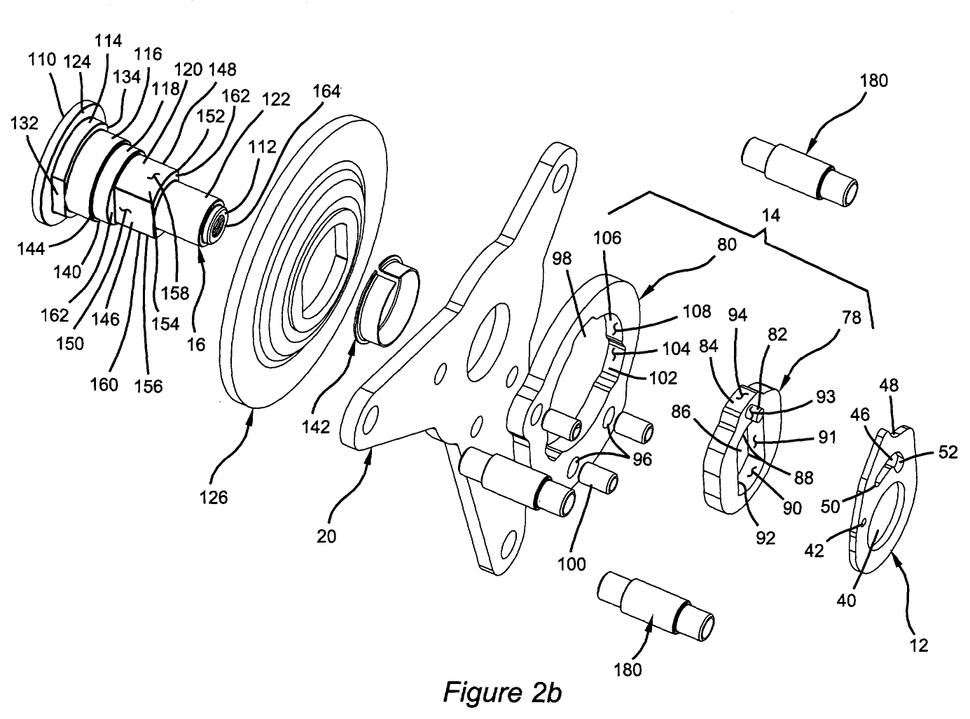

As best seen in FIG. 2b, the sector plate 80 is a generally flat plate having attachment apertures 96 and a central aperture 98 formed therethrough. Attachment rivets 100 are provided and are received through the attachment apertures 96 for fixedly attaching the sector plate 80 to the first striker plate 20. The inner diameter surface of the sector plate 80 defining the central aperture 98 includes a plurality of locking recesses 102, each having an engagement face 104. Further, the inner diameter surface defining the central aperture 98 includes a plurality of intermediate surfaces 106 each having a reaction surface 108.

As shown in FIGS. 2a and 2b, the main pivot 16 is an elongate body having a generally cylindrical shape and supports the body 18, locking assembly 14 and actuation member 24 thereon. The main pivot 16 further includes first and second ends 110,112, and first 114, second 116, third 118, fourth 120, and fifth 122 cylindrical sections.

The first end 110 of the main pivot 16 includes an axial flange 124 for engagement with a striker mounting bracket 126. In one embodiment, the striker mounting bracket 126 is a circular disk with a central recess 128 having a central aperture 130 formed therethrough for mating engagement with the first cylindrical section 114. The axial flange 124 of the main pivot 16 is received into the axial recess 128 of the striker mounting bracket 126, whereby the aperture 130 of the mounting bracket 126 matingly receives the first cylindrical section 114 of the main pivot 16. The first cylindrical section 114 of the main pivot 16 includes flats 132,134 for mating engagement with flats 136,138 of the striker mounting bracket 128 to prevent relative rotation thereof. While the present invention discloses a striker mounting bracket 126 as a separate member, the striker mounting bracket 126 may be integrally formed on the main pivot 16 for attachment to a vehicle or other structure.

The second cylindrical 116 section of the main pivot 16 is disposed between the first and third cylindrical sections 114,118, having a smaller cross-sectional diameter than that of the first cylindrical section 114 and a larger cross-sectional diameter than that of the third cylindrical section 118, and serves to provide clearance between the first striker plate 20 and the striker mounting bracket 126. The difference in cross-sectional diameter between the second and third cylindrical sections 116,118 forms a ridge 140 at their junction to create an engagement surface 144 for receiving a second bushing 142.

The fourth cylindrical section 120 of the main pivot 16 includes two flats 146,148 having reaction faces 150,152 for slidable engagement with the slider plate 78. Flats 146,148 further engage feet 74,76 of spring anchor 62 to prevent rotation of the spring anchor 62 relative to the main pivot 16. The fourth cylindrical section 120 also includes first and second arcuate surfaces 154,156 having bearing surfaces 158,160 for rotational engagement with the cam plate 12. The fourth cylindrical section 120 is disposed between the third cylindrical section 118 and the fifth cylindrical section 122, having a smaller cross-sectional diameter than that of the third cylindrical section 118 and a larger cross-sectional diameter than that of the fifth cylindrical section 122. The difference in cross-section between the fourth and fifth cylindrical sections 120,122 forms a ridge 162 at their junction for receiving and supporting the spring anchor 62.

The fifth cylindrical section 122 of the main pivot 16 has a uniform cross-section along its length and mounts the spring anchor 62 thereon. The fifth cylindrical section 122 is disposed at the second end 112 of the main pivot 16 and includes a threaded bore 164 for mating engagement with a cover bolt 36.

The body 18 includes first and second striker plates 20,22, strikers 180, and sector rivets 100. In one embodiment, the first striker plate 20 has three extensions 168,170,172 having varying lengths and engagement faces radiating from a main pivot aperture 174. Further, the first striker plate 20 includes striker apertures 176 disposed at a distal end of each extension 168,170,172 and attachment apertures 178 formed around the main pivot aperture 174.

The first striker plate 20 is fixedly attached to the second striker plate 22 by strikers 180 with the locking assembly 14, cam plate 12, spring anchor 62, and cam return spring 44 disposed therebetween. Each striker 180 includes a central cylindrical bearing surface 182 flanked by two cylindrical sections 184,186 received into striker apertures 176 of the first and second striker plates 20,22 respectively. The first striker plate 20 includes the second bushing 142 and is rotatably received by the third cylindrical section 118 of the main pivot 16. The second bushing 142 interfaces between the main pivot aperture 174 of the first striker plate 20 and the main pivot 16. The second striker plate 22 is similarly attached to the fifth cylindrical section 122 of the main pivot 16 and includes the first bushing 68 for interaction between the main pivot aperture 188 of the second striker plate 22 and the first cylindrical section 64 of the spring anchor 62. Further, the main aperture 188 of the second striker plate 22 rotatably receives the inner extrusion 38 of the actuation member 24 with a washer 190 disposed therebetween. The second striker plate 22 is substantially similar to the first striker plate 20 whereby like components have been identified in the description and in the drawings with like reference numerals.

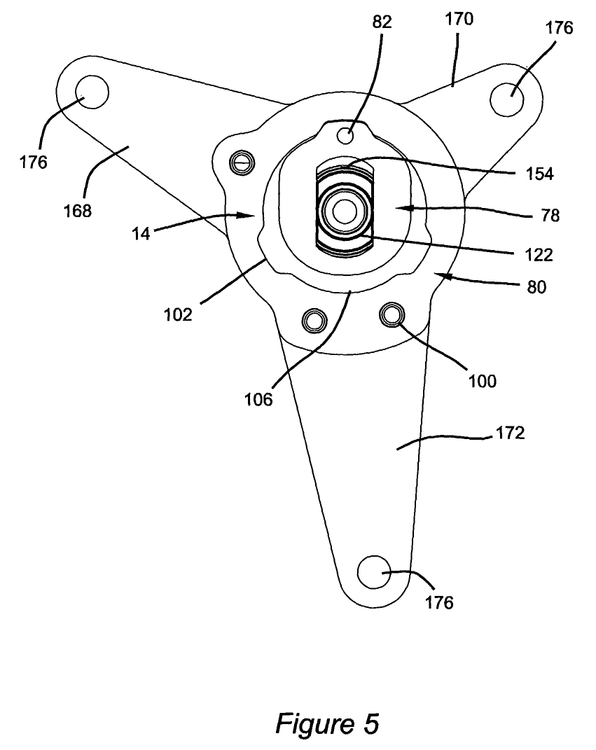

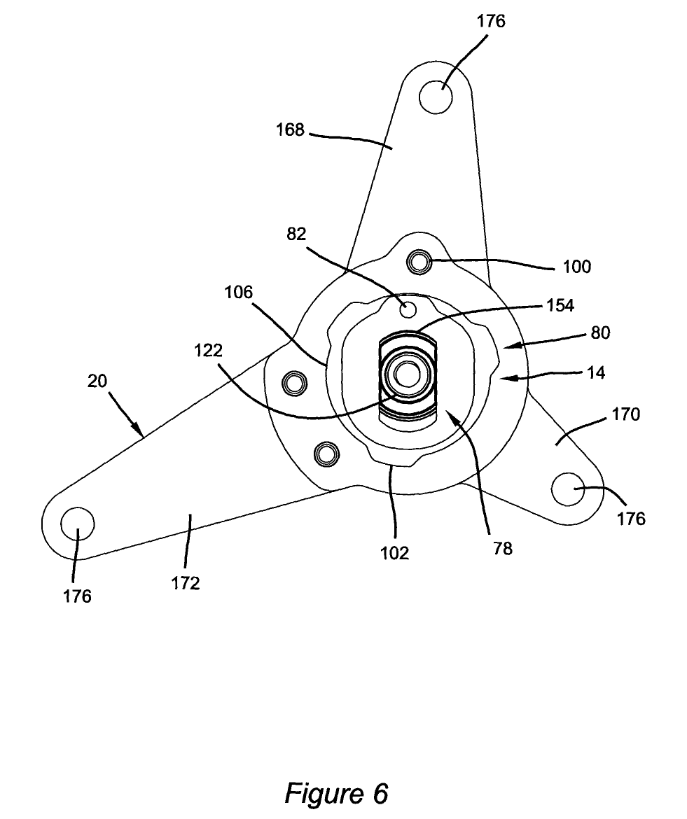

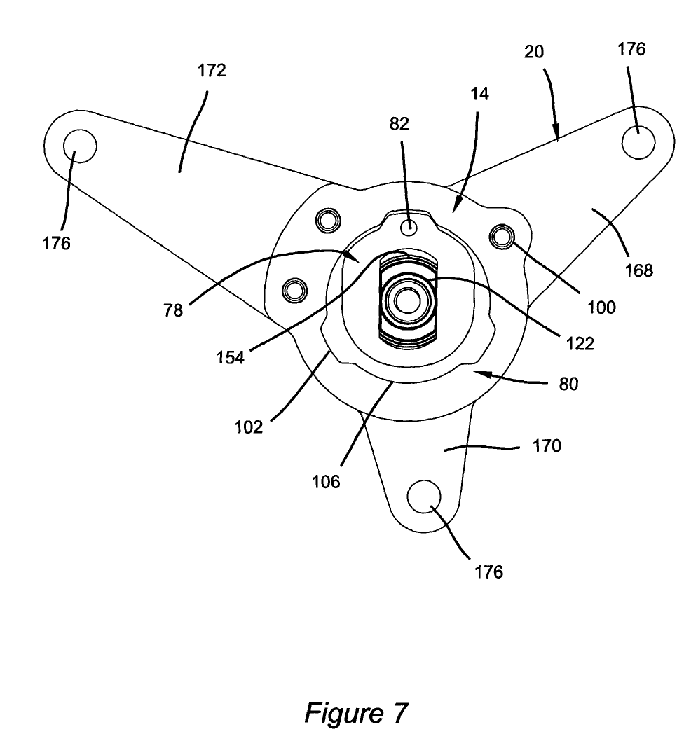

With particular reference to FIGS. 5-7, the operation of the adjustment mechanism 10 will be described in detail. In one embodiment, the adjustment mechanism 10 allows for three rotational positions of the body 18 relative to the main pivot 16 and is selectively actuated by a force applied to the actuation member 24 of the adjustment mechanism 10 to toggle the adjustment mechanism 10 between an locked and an unlocked position.

Applying a force to the actuation member 24 causes the actuation member 24 to rotate in a second rotational direction (forward direction) about the fifth cylindrical section 122 of the main pivot 16, subsequently causing the engagement face of the inner extrusion 38 to react with the engagement face 48 of the cam plate 12. Further rotation of the actuation member 24 induces rotation of the cam plate 12 about the fourth cylindrical section 120 of the main pivot 16, causing the cam plate 12 to be biased by the cam return spring 44 in a first rotational direction and causing the cam slot 46 to rotate such that the slider post 82 moves away from engagement with the first end 50 of the cam slot 46. Continued rotation of the cam plate 12 forces the slider post 82 to travel along the cam slot 46 until sufficiently rotated such that the slider post 82 contacts the second end 52 of the cam slot 46.

Movement of the slider post 82 from the first end 50 of the cam slot 46 to the second end 52 of the cam slot 46 causes the slider plate 78 to slide along the flats 146,148 of the fourth cylindrical section 120 of the main pivot 16 until the first reaction surface 88 of the slider plate 78 contacts the first arcuate surface 154 of the fourth cylindrical section 120 of the main pivot 16. Movement of the slider plate 78 to a position such that the slider plate 78 contacts the first arcuate surface 154 of the fourth cylindrical section 120 of the main pivot 16 disengages the engagement face 94 of the locking flange 84 from a reaction face 104 of one of the locking recesses 102 of the sector plate 80, thereby disengaging the slider plate 78 from the sector plate 80, and allowing the body 18 to rotate relative to the main pivot 16 and the slider plate 78.

Rotation of the body 18 is now allowed and is accomplished through further rotation of the actuation member 24 in the second rotational direction (forward direction). Once the slider plate 78 is disengaged from the sector plate 80, further rotation of the actuation member 24 in the second rotational direction causes the engagement faces of the engagement arms 30 to contact the engagement faces of the first and second striker plates 20,22 and further causes the inner extrusion 38 of the actuation member 24 to disengage the cam plate 12 thereby allowing the cam return spring 44 to bias the cam plate 12 in the first rotational direction. Further rotation of the actuation member 24 in the second rotational direction will now cause the first and second striker plates 20,22 to rotate, subsequently rotating the body 18 and the sector plate 80 relative to the slider plate 78 and the main pivot 16.

Rotation of the body 18 causes the locking flange 84 to move from a position just under a locking recess 102 to engagement with one of the intermediate surfaces 106 of the sector plate 80 as best shown in FIGS. 5-7. The locking flange 84 is held in slidable engagement with the intermediate surface 106 of the sector plate 80 due to the bias of the cam return spring 44 on the cam plate 12. Further rotation of the actuation member 24 in the second rotational direction causes the body 18 to rotate until the locking flange 84 is a again in a position to engage a locking recess 102 of the sector plate 80. At this point, the cam return spring 44 again biases the cam plate 12 in the first rotational direction and subsequently causes the cam plate 12 to rotate, thereby causing the slider post 82 to disengage from the second end 52 of the cam slot 46 and to travel along the cam slot 46 to the first end 50 of the cam slot 46. The movement of the slider post 82 in the cam slot 46 causes the slider plate 78 to again slide along the flat sides 146,148 of the fourth cylindrical section 120 of the main pivot 16 until the second reaction surface 90 contacts the second arcuate surface 156 of the fourth cylindrical section 120. At this point, the engagement face 94 of the locking flange 84 is again in contact with an engagement face 104 of one of the locking recesses 102. At this point, the adjustment mechanism 10 is returned to a locked position.

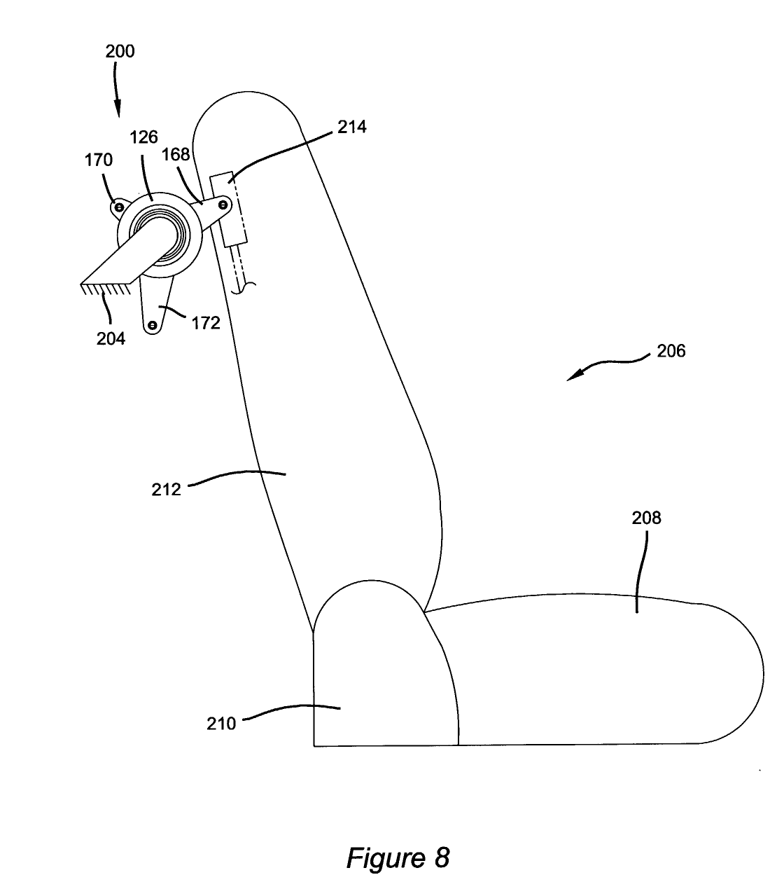

In one embodiment, the adjustment mechanism 10 is an adjustable striker assembly 200 including a body 18 having a plurality of extensions 168,170,172, each having a different length, thereby providing for a plurality of striker locations through rotation of the body 18 relative to the main pivot 16. As shown in FIG. 8, the adjustable striker assembly 200 is fixedly attached to a vehicle structure 204 through the striker mounting bracket 126. Further, a seat 206 is provided having a seat bottom 208, a seat pivot 210, and a seat back 212 having a latch mechanism 214 mounted thereto. The adjustable striker assembly 200 provides a means for the latch mechanism 214 to attach to the vehicle structure 204.

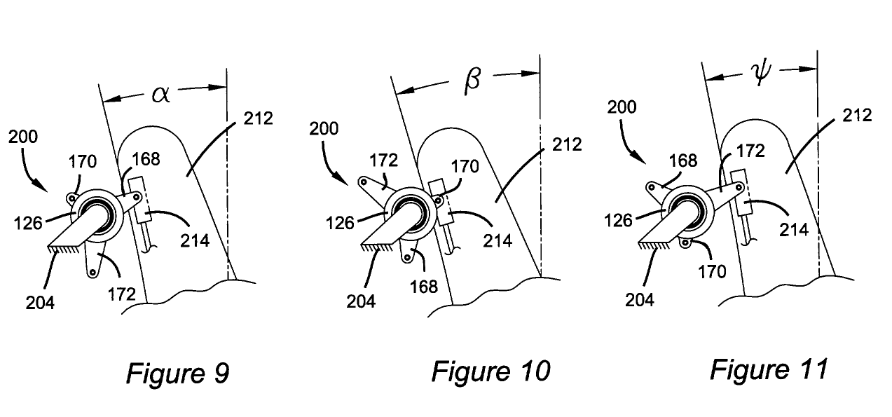

The bearing surfaces 182 of the strikers 180 interact with the latch mechanism 214 to selectively attach the seat back 212 to the vehicle structure 204. As best shown in FIGS. 9-11, the adjustable striker assembly 200 provides for a plurality of seatback 212 positions relative to the seat bottom 208. Rotation of the seat back 212 relative to the seat bottom 208 is achieved through rotation of the seat back 212 about the seat pivot 210. The adjustable striker assembly 200 allows the seat back 212 to be selectively positioned in a number of angled positions as shown in FIGS. 9-11 and indicated by α, β, and, ψ respectively. Each position of the seat back 212 is achieved through different positions of the adjustable striker assembly 200 while adjustment of the striker 180 position is achieved through rotation of the body 18 as described above, until the desired extension 168,170,172 length is achieved. In one embodiment, the adjustable striker assembly 200 provides for three different striker 180 positions as achieved by the varying lengths of the striker extensions 168,170,172. While the present invention provides three adjustment positions, it should be noted that an increase or decrease of the number of adjustment positions is anticipated and should be considered within the scope of the present invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A seat adjustment mechanism for securing a seat portion relative a vehicle body, said seat adjustment mechanism, comprising:
a main pivot adapted for attachment to the vehicle body;
a body rotatably supported by said main pivot;
a locking assembly operably supported by said body, said locking assembly operable between a locked position and an unlocked position; and
a cam plate rotatably supported by said main pivot and in operable communication with said locking assembly to selectively lock said body in a plurality of positions relative to said main pivot.

2. The seat adjustment mechanism of claim 1, further comprising a biasing member for biasing said cam plate towards positioning said locking assembly in a locked position.

3. The seat adjustment mechanism of claim 2, wherein said biasing member is a spring.

4. The seat adjustment mechanism of claim 1, wherein said locking assembly further includes a slider plate slidably supported by said main pivot, and a sector plate fixedly supported by said body.

5. The seat adjustment mechanism of claim 4, wherein said slider plate interfaces with said cam plate to slidably position said slider plate.

6. The seat adjustment mechanism of claim 4, wherein said sector plate further includes a plurality of locking recesses for receiving said slider plate.

7. The seat adjustment mechanism of claim 1, wherein said body includes a plurality of strikers.

8. The seat adjustment mechanism of claim 7, wherein said body includes a pair of striker plates supporting said plurality of strikers.

9. The seat adjustment mechanism of claim 8, wherein said pair of striker plates support each of said plurality of strikers at varied radii from said main pivot.

10. The seat adjustment mechanism of claim 1, further comprising an actuation member for interaction with said cam plate and said body for axial rotation thereof.

11. The seat adjustment mechanism of claim 1, wherein said main pivot further includes a mounting bracket for attachment to a vehicle body.

12. A seat adjustment mechanism, comprising:
a main pivot adapted for attachment to a vehicle body;
a body rotatably supported by said main pivot and including a plurality of strikers disposed at varying radii from said main pivot;
a locking assembly operably supported by said body, said locking assembly operable between a locked position and an unlocked position; and
a cam plate rotatably supported by said main pivot and in operable communication with said locking assembly to selectively lock said body in a plurality of positions relative to said main pivot.

13. The seat adjustment mechanism of claim 12, further comprising a biasing member for biasing said cam plate towards positioning said locking assembly in a locked position.

14. The seat adjustment mechanism of claim 13, wherein said biasing member is a spring.

15. The seat adjustment mechanism of claim 12, wherein said locking assembly includes a sector plate fixedly supported by said body and a slider plate slidably supported by said main pivot.

16. The seat adjustment mechanism of claim 15, wherein said sector plate further includes a plurality of locking recesses for receiving said slider plate.

17. The seat adjustment mechanism of claim 15, wherein said cam plate is in operable communication with said slider plate.

18. The seat adjustment mechanism of claim 12, further comprising an actuation member for interaction with said cam plate and said body for axial rotation thereof.

19. The seat adjustment mechanism of claim 12, wherein said main pivot further includes a mounting bracket for attachment to a vehicle body.

20. An adjustable seat assembly, comprising:
a seat;
a seat back pivotably interconnected to said seat through a recliner mechanism;
a seat latch for releasably securing said seat back to a vehicle structure; and
an adjustable striker wheel coupled to said vehicle structure for receiving said seat latch.

21. The adjustable seat assembly of claim 20, wherein said adjustable striker wheel includes:
a main pivot adapted for attachment to a vehicle body;
a body rotatably supported by said main pivot and including a plurality of strikers disposed at varying radii from said main pivot;
a locking assembly operably supported by said body, said locking assembly operable between a locked position and an unlocked position; and
a cam plate rotatably supported by said main pivot and in operable communication with said locking assembly to selectively lock said body in a plurality of positions relative to said main pivot.

22. The adjustable seat assembly of claim 21, further comprising a biasing member for biasing said cam plate towards positioning said locking assembly in a locked position.

23. The adjustable seat assembly of claim 22, wherein said biasing member is a spring.

24. The adjustable seat assembly of claim 21, wherein said locking assembly includes a sector plate fixedly supported by said body and a slider plate slidably supported by said main pivot.

25. The adjustable seat assembly of claim 24, wherein said sector plate further includes a plurality of locking recesses for receiving said slider plate.

26. The adjustable seat assembly of claim 24, wherein said cam plate is in operable communication with said slider plate.

27. The adjustable seat assembly of claim 21, further comprising an actuation member for interaction with said cam plate and said body for axial rotation thereof.

28. The adjustable seat assembly of claim 21, wherein said main pivot further includes a mounting bracket for attachment to a vehicle body.
